(19) United States
(12) Patent Application Publication
(10) Pub. No.: US 2008/0159069 A1
(43) Pub. Date: Jul. 3, 2008

(54) Inlet Section for Micro-Reactor

(75) Inventors: Martijn Jacobus Marinus Mies, Eindhoven (NL); Evgeny Victorovich Rebrov, Eindhoven (NL); Martien Hendrik Jozef Marie De Croon, Eindhoven (NL); Jacob Cornelis Schouten, Nijmegen (NL); Ilyas Zinferovich Ismagilov, Novosibirsk (RU)

Correspondence Address: MORGAN & FINNEGAN, L.L.P., 3 WORLD FINANCIAL CENTER, NEW YORK, NY, 10281-2101, US

(73) Assignee: Stichting Voor De Technische Wentenschappen, Utrecht (NL)

(21) Appl. No.: 11/910,879

(22) PCT Filed: Apr. 6, 2006
(86) PCT No.: PCT/NL06/50074

§ 371 Date: Jan. 10, 2008

(30) Foreign Application Priority Data
Apr. 6, 2005 (NL) 2005/000260

(51) Int. Cl. B01F 13/00

(52) U.S. Cl. 366/340

(57) ABSTRACT

Inlet section for providing a uniform flow distribution in a downstream reactor (14) which is connectable to the inlet section (10). The inlet section has an inlet diffuser (11) for receiving a fluid flow, an upstream passage (12) positioned downstream from the inlet diffuser (11), and a downstream passage (13) positioned downstream of the upstream passage (12). The upstream passage and downstream passage each comprise thick wall screens (12, 13). The upstream passage (12) has a first plurality (m) of elongated parallel upstream channels (15), and the downstream passage (13) has a second plurality (n) of elongated parallel downstream channels (16). The elongated upstream channels (15) are positioned at an angle of substantially 90 degrees with respect to the elongated downstream channels (16).

### FIELD OF THE INVENTION

The present invention relates to an inlet section for providing a uniform flow distribution in a downstream reactor connectable to the inlet section, comprising an inlet diffuser for receiving a fluid flow, an upstream passage positioned downstream from the inlet diffuser, and a downstream passage positioned downstream of the upstream passage, in which the upstream passage and downstream passage comprise thick wall screens.

### PRIOR ART

Such an inlet section is e.g. known from the publication WO03/031053, which describes a distribution structure, especially suited for producing combustion gas for low temperature fuel cells. The structure comprises an expanding inlet diffuser, and two or more baffles (thin screens) in the inlet diffuser, which are arranged to obtain a uniform flow entry into the fuel cell.

Document U.S. Pat. No. 3,996,025 describes a diffuser device for distributing flowing media from one flow cross section to a different flow section, in a funnel shaped tubular enclosure open at both ends. A plate having a multiplicity of parallel passage canals is arranged perpendicular to the axis of the tubular enclosure leaving free passage openings between the edge of the plate and the tubular enclosure and the flared opening of the funnel shaped tubular enclosure is filled by an end plate with a multiplicity of parallel passage canals. Such an arrangement is useable in applications where the pressure difference over the diffuser device is large.

### SUMMARY OF THE INVENTION

The present invention seeks to provide an inlet section for a reactor, such as a high throughput experimental reactor (HTER) or other types of micro-reactors, in which the flow through the reactor is highly stable throughout the entire reactor cross section. The temperature profile and flow profile must be the same for each and every reactor channel of a reactor. In fixed bed chemical reactors, catalyst layers provide for additional flow resistance, effectively contributing to creating a uniform flow distribution. In micro-structured reactors, however, the pressure drop over the entire reactor seldom exceeds 5% of the pressure at the reactor outlet. For these type of reactors, a uniform flow requires additional measures, e.g. in the form of upstream equalizing and distribution devices.

Prior art solutions have used porous inlet sections, e.g. of ceramic material. However, the pressure drop over such a porous inlet section is too high for many applications. Other solutions, such as the distribution structure from WO03/031053 mentioned above, have proposed to use one or more thin wall screens in the inlet section, however, these fail to provide a sufficiently even flow distribution over all reaction channels in a reactor.

According to the present invention, an inlet section according to the preamble defined above is provided, in which the upstream passage comprises a first plurality of elongated parallel upstream channels, and the downstream passage comprises a second plurality of elongated parallel downstream channels and the elongated upstream channels are positioned at an angle of substantially 90 degrees with respect to the elongated downstream channels. Thick wall screens are screens of which the length in flow direction is larger than the spacing between respective walls of the screen, and are also indicated by the term three-dimensional screen. The present arrangement of the inlet section allows to obtain a highly uniform distribution of fluid flow at the end face of the inlet section (or to the inlet face of a downstream reactor), regardless of the fluid flow distribution profile at the inlet face of the upstream passage. The use of elongated parallel channels in the upstream and downstream passage is especially suited for equalizing the fluid flow distribution in the inlet section. This arrangement provides the best equalization of the fluid flow, especially when the downstream reactor comprises a plurality of reaction channels in a grid form (i.e. multiple reaction channels in both cross sectional dimensions of the downstream reactor).

In an even further embodiment, a b/a ratio is equal to or greater than 0.5, in which a is the distance between two neighboring downstream channels and b is the distance in cross sectional view between a top wall of the downstream channels and a side wall of the upstream channels. In other words, the value b is the overhang of the cross section of upstream channels with respect to the cross section of downstream channels. In an even further embodiment, the b/a ratio is chosen in the region between 0.5 and 2.0.

Advantageously, the b/a ratio is equal to a predetermined optimum value. At a certain embodiment (a=250 μm; c=300 μm; d=400 μm; h=300 μm; d being the width of the downstream channel, h being the space between the upstream channels) a b/a ratio of 0.75 was found to be optimal. At another embodiment (a=400 μm; c=800 μm, d=400 μm, h=300 μm) a b/a ratio of 0.65 was found to be optimal.

In a further embodiment, the b/a ratio is changed depending on the distance a between two neighboring downstream channels. This will also allow to obtain a wider range of acceptable b/a ratios by changing the distance a between two neighboring downstream channels. This allows to obtain a more robust design of the inlet section. When the acceptable b/a ratio is wider, manufacturing tolerances of micro-machining equipment have less influence of the eventually resulting fluid flow non-uniformity.

According to a further embodiment, the distance b is determined as a function of design parameters a, c, d, x⁺ from the equation

$$b ( a , c , d , {x}^{+} ) = 0.5 \cdot a + ( 0.1678 + 0.035 \cdot {e}^{- 0.840 \cdot {x}^{+} + \frac{0.1986}{{x}^{+}}} ) \cdot c + ( - 1.06 + 8.47 \cdot {10}^{- 3} \cdot c + 8.00 \cdot {10}^{- 6} \cdot {c}^{2} ) \cdot {e}^{- 1.02 \cdot \frac{d}{c}}$$

c being the width of the upstream channel, d the height of the downstream channel, and x⁺ the dimensionless length of the upstream channel

$${x}^{+} = \frac{L}{{D}_{h} Re} ,$$

in which L is the upstream channel length, Re the Reynolds number, and Dₕ the hydraulic radius given by

$${D}_{h} = \frac{4 A}{P} ,$$

A being a channel cross sectional area, and P being the channel perimeter. This equation is obtained by striving to equalise the flow between the two outermost channels. From other design parameters a, c, d, and the upstream dimensionless length x⁺, with this embodiment it is possible to determine the optimum value of the offset b.

The width of the downstream channels and the space between the downstream channels are substantially equal to the width of reaction channels and the space between reaction channels of the downstream reactor, respectively in a further embodiment, to allow an optimal connection between the inlet section and downstream reactor without any additional pressure loss or additional resistance for the fluid flow.

In a further embodiment, in which the width of the downstream channels and the space between the downstream channels are substantially equal to the width of a group of reaction channels and the space between groups of reaction channels of the downstream reactor, respectively, a group of reaction channels comprising an integer number of horizontal sets of reaction channels. This allows e.g. to use the present inlet section having 150 downstream channels to be connected to a micro-reactor having 600 horizontal sets of reaction channels. As a result, the inlet section can be manufactured more easily, with only minor effect on the flow equalization.

The ratio of open cross section of the upstream passage and open cross section of the inlet diffuser is equal to or greater than substantially 3, e.g. greater than 10. This situation is typical for micro-reactor technology, and the thick wall screen of the present inlet section is well suited for providing a uniform fluid flow distribution.

In a further embodiment of the present invention, the relative length of both the upstream passage and the downstream passage is equal to or greater than 7.5, the relative length being equal to the ratio of the length of the passage in flow direction and the hydraulic diameter of the channel. In the case of elongated channels, the hydraulic diameter is equal to twice the width of the elongated channels. It has been found that below the given relative length, flow non-uniformity will increase.

Advantageously, the first plurality of upstream channels may comprise any number of channels, e.g. eight, in which the number of channels depends on the above defined relative length and the open cross-section of the reaction channels. In typical micro-reactor set-ups, this provides a sufficiently uniform fluid flow distribution at the entry of the micro-reactor. Furthermore, the first plurality of upstream channels comprises at least a predetermined number of channels. It has been found that a predetermined number of channels exist, beyond which flow non-uniformity is not further improved. In exemplary embodiment, an improvement was observed when increasing the number of channels from 8 to 11, but no further improvement was observed when increasing the number of channels from 11 to 22.

The width c of the upstream channels is in an even further embodiment equal to or less than 1000 μm. In typical micro-reactor arrangement this provides for a sufficiently low non-uniformity of the fluid flow distribution at the outlet face of the inlet section.

Using the present inlet section, the fluid flow non-uniformity at the inlet section outlet face is independent from the fluid flow distribution at the inlet face. Therefore, it is possible to use an inlet diffuser with an opening angle up to substantially 180° (sudden expansion). This reduces the volume of possibly explosive gases in the inlet section of a micro-reactor arrangement.

In an even further embodiment, the inlet section comprises one or more heating devices for heating the fluid flow. Because of the uniform flow obtained by the present invention, the fluid flow can be heated very uniformly as well, as a result of which all reaction channels of the downstream reactor receive fluid of the same temperature. Advantageously, the inlet section is provided with one or more temperature sensors, which allow to control the fluid flow temperature.

### SHORT DESCRIPTION OF DRAWINGS

The present invention will be discussed in more detail below, using a number of exemplary embodiments, with reference to the attached drawings, in which

FIG. 1 shows an exploded perspective view of an inlet section according to an embodiment of the present invention in combination with a reactor;

FIG. 2 shows a cross sectional view of the upstream passage in downstream direction;

FIG. 3 shows a top view of an inlet section attached to a reactor;

FIG. 4 shows a plot of flow non-uniformity as function of b/a ratio for a number of downstream channel widths c;

FIG. 5a shows a schematic representation of streamlines for the top and middle channels of the inlet section of FIG. 1, in frontal view on the left and in cross sectional view on the right, and FIG. 5b shows the same for intermediate channels of the inlet section;

FIG. 6 shows a plot of the response function versus distance a;

FIG. 7 shows a plot of the optimal b/a ratio as function of distance a between downstream channels for a number of upstream channel widths c; and

FIG. 8 shows a plot of allowable b/a ratios as function of distance a between downstream channels for an upstream channel width c=300 μm providing a flow non-uniformity of less than 0.5%.

### DETAILED DESCRIPTION OF EXEMPLARY EMBODIMENTS

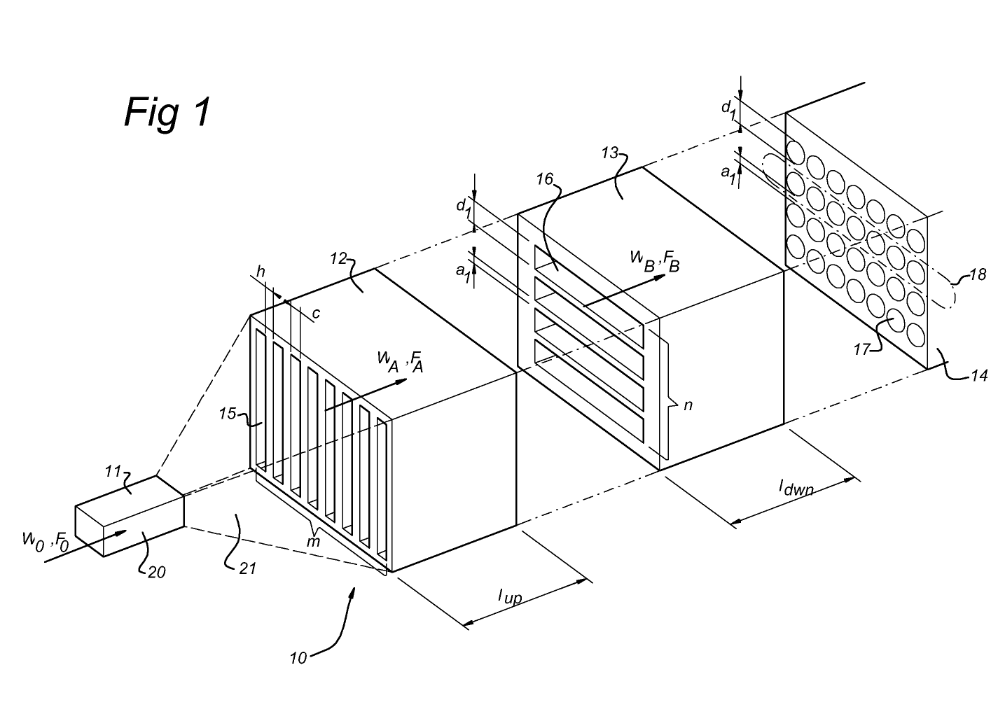

In FIG. 1 an exploded perspective view is shown of a first embodiment of an inlet section 10 for a micro-reactor 14. The face of the micro-reactor 14 shows that the micro-reactor 14 comprises a large number of reaction channels 17. In the vertical dimension, the reaction channels 17 have a height d₁, and a distance between reaction channels 17 equal to a distance a₁. Of course, the micro-reactor 14 may be provided with a larger or smaller number of reaction channels 17, having a circular cross section as shown or alternatively a rectangular cross section. The present inlet section 10 is suited for use with a wide variety of reactors 14, in particular micro-reactors such as a HTER reactor.

The inlet section 10 comprises a diffuser 11, an upstream thick wall screen 12, and a downstream thick wall screen 13. In operation, the diffuser 11, the upstream passage 12, downstream passage 13, and micro-reactor 14 are positioned next to each other, as shown in the top view of FIG. 3.

The diffuser 11 comprises an inlet channel 20 into which the reaction fluid enters the combination of inlet section 10 and micro-reactor 14, and a diffuser expansion part 21. The angle α of the diffuser expansion part 21 determines the velocity profile at the entrance to the upstream passage 12. In micro-reactor technology it is desirable to avoid large volumes of potentially explosive gasses, and thus a large angle α is desired, e.g. an angle with α≧40°. An angle of near α=180° provides the smallest possible volume of the diffuser expansion part 21. It has been found that with an angle α larger than 40°, the main stream will separate completely from the diffuser walls at the connection between inlet channel 20 and diffuser expansion part 21. The resulting velocity profile at the entrance to the upstream passage 12 will in this case have a ratio of maximum velocity to the mean velocity of more than 2.

In order to assure that the reaction fluids enter all of the reaction channels 17 of the micro-reactor 14 under the same conditions, the upstream and downstream passage 12, 13 are provided to equalise the fluid flow.

The upstream passage 12 and downstream passage 13 are of the thick-walled type, comprising a number of m upstream channels 15 and n downstream channels 16, below indicated as [m×n] configuration. Thick walled, or three-dimensional, means that the length lᵤₚ of the upstream passage 12, and the length l_{dwn} of the downstream passage 13, in the flow direction is large compared to the spacing between respective walls of the passage. Thus for the embodiment shown in FIG. 1, lᵤₚ>h, in which h is the distance between two neighbouring upstream channels 15, and l_{down}>a, in which a is the distance between two neighbouring downstream channels 16. The parameters a and d (d being the width of the downstream channel 16) of the downstream passage 13 are adapted to the arrangement of the reaction channels 17 of the micro-reactor 14. E.g. the width d is equal to or slightly larger than the diameter of the reaction channels 17. The inter-channel distance a of the downstream channels 16 is adapted such that the channels 16 are aligned with the reaction channels 17. In the figures, c is the width of the upstream channel 15.

In a further embodiment, the opening of the downstream channels 16 corresponds to the position of groups of reactor channels 17 in the micro-reactor 14. Each group may e.g. comprise 1, 2, 3 or 4 horizontal sets 18 of reactor channels in the width direction of the associated downstream channel 16. This allows e.g. to connect a micro-reactor 14 having 600 horizontal sets 18 of reaction channels 17 to an inlet section having 600, 300, 200 or 150 downstream channels 16.

The present inlet section 10 can be used advantageously especially for micro-reaction technology. In micro-reaction technology, the ratio between the open cross section F_{A} of the upstream passage 12 and the open cross section F_{O} of the inlet diffuser 11 is typically greater than 3, and in some cases greater than 10 (see FIG. 1). In this case, planar screens or thin wall screens cannot provide a uniform fluid flow distribution, however, the thick wall screens 12, 13 as used in the inlet section according to the present invention are able to provide a substantially uniform flow distribution.

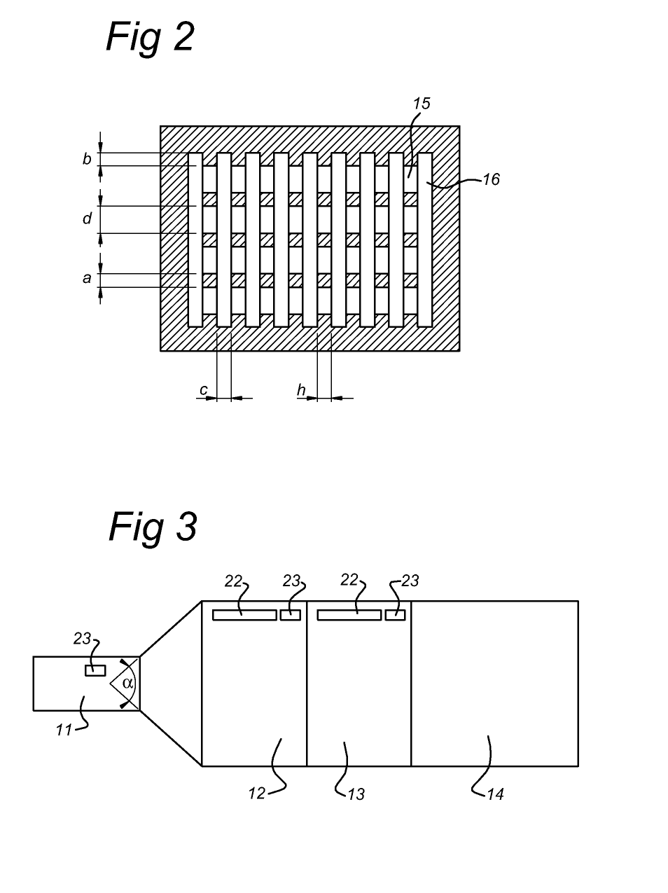

In the embodiment shown, the upstream channels 15 and downstream channels 16 are elongated channels, the upstream channels 15 being at an angle of substantially 90° with the downstream channels 16. A further design parameter of the inlet section 10 is the minimum distance b between the top wall of the downstream passage 13 and a side wall of the upstream passage 12, as depicted in the cross sectional view of FIG. 2. In other words, the distance b is the overhang of the cross section of upstream channels 15 with respect to the cross section of downstream channels 16.

This configuration of the inlet section 10 assures that a uniform flow distribution can be obtained at the entrance of the reaction channels 17, regardless of whether the flow distribution at the inlet is uniform or not (e.g. elongate velocity profile or parabolic velocity profile).

It has been found that a number of parameters of the inlet section can influence the uniformity of the fluid flow at the entrance of the micro-reactor.

A first design parameter is the relative length of the upstream and downstream passage 12, 13, defined as the ratio of the passage length (lᵤₚ; l_{dwn}) to the hydraulic diameter of a flow channel. In this case, the hydraulic diameter is twice the passage channel width (i.e. 2c, and 2d, respectively). When the relative length lᵣₑₗ>7.5, the other design parameters are not influenced by lᵣₑₗ.

A further design parameter which influences the uniformity of the flow at the entrance to the micro-reactor 14 is the distance b as defined above. This distance should create exactly enough room for fluid to distribute in the outermost channels 16 of the downstream passage 13. At a ratio b/a of more than 0.5, flow of fluid is found to be present in the outermost channels 16. Increasing this ratio will allow more flow to go to the outermost downstream channels 16, thus lowering the flow non-uniformity. As a design rule, the b/a ratio should thus be larger than 0.5. Furthermore, an upper limit of the b/a ratio of 2.0 should be adhered to (thus 0.5≦b/a≦2.0).

In an example of an inlet section 10 according to the present invention, the design parameters for an inlet section 10 for a micro-reactor having [22×8] reactor channels 17 were chosen as: a=250 μm, c=300 μm, d=400 μm, and h=300 μm. Flow non-uniformity at the micro-reactor 14 entrance was defined as

$$δ = \frac{100}{\overline{v}} \cdot \sqrt{\frac{{\sum }_{j = 1}^{n} {( {v}_{j} - \overline{v} )}^{2}}{( n - 1 )}} \% ,$$

in which v̅ is the mean velocity over all outlet channels (end face of downstream channels 16), and vⱼ is the area average velocity in the outlet channel j. It was found that in this case, an optimum b/a ratio exists (b/a=0.75) at which the flow non-uniformity has a minimum value (δ=0.180%). Both lower b/a value of 0.73 and higher b/a value of 0.77 gave larger values of the flow non-uniformity of 0.213% and 0.218%, respectively.

In further experimental set-ups, the effect of the number m of upstream channels 15 was investigated. Values for flow non-uniformity were obtained for both [22×8] geometry [11×8] and for [8×8] geometry inlet sections 10. The same values for c, h, and d were used. Comparison was made for two cases of distance a between downstream channels 16 (a=250 μm; a=400 μm). It was found that increasing the number of upstream channels 16 from 8 to 11 resulted in a decrease of the flow non-uniformity, while the optimum b/a ratio remained the same. Further increase of the number of upstream channels 16 from 11 to 22 did not result in a significant change of the flow non-uniformity. Thus it can be concluded that a minimum number of upstream passages exist (in this example m=11) beyond which flow non-uniformity remains constant. This is advantageous from a manufacturing viewpoint, as a larger number of channels 16 increases fabrication costs.

Furthermore, it was found that increasing the separation a between downstream channels 16 results in a shift of the optimum b/a ratio to lower values. The distance a may be chosen between 100 μm en 1000 μm. At constant width c of the upstream channels 15, the optimum b/a ratio is then a function of the distance a between downstream channels 16.

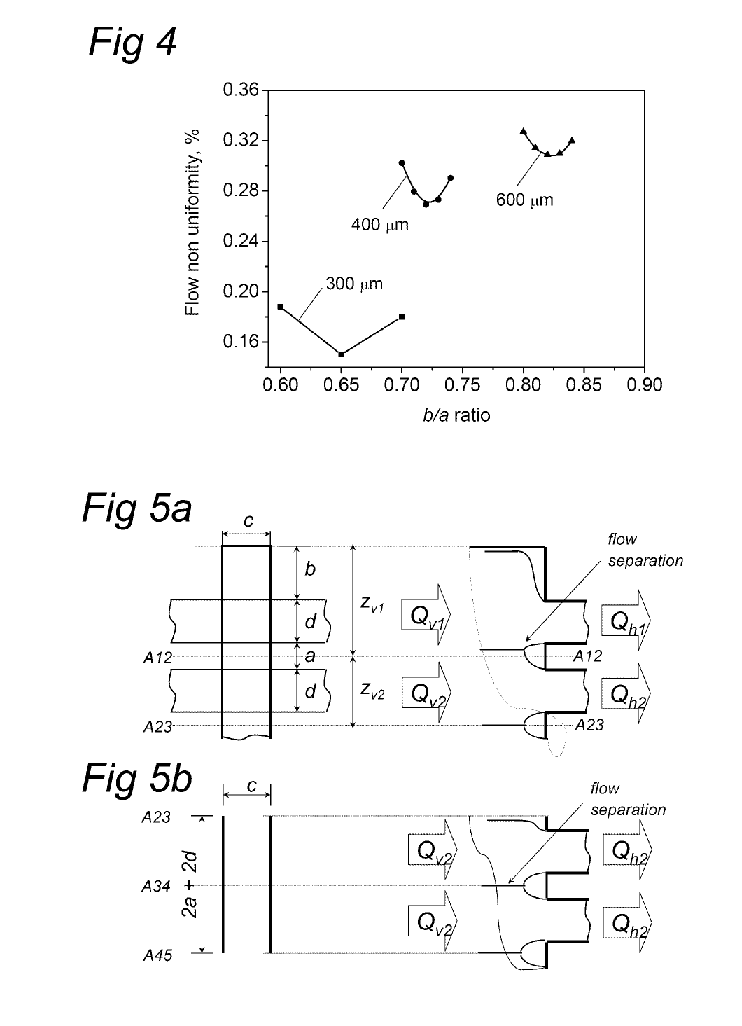

In a further series of exemplary embodiments, the influence of the upstream channel width c in relation to the flow non-uniformity δ was investigated. The relative length of the upstream passage 12 was kept the same at lᵤₚ/2c=7.5, and the parameters a, d of the downstream passage 13 were kept constant at a=400 μm and d=400 μm. A [22×8] geometry with c=800 μm, a [45×8] geometry with c=400 μm, and a [22×8] geometry with c=300 μm were compared. The results are shown in the plot of FIG. 4. At a fixed distance a, the optimal b/a ratio increases with increasing distance c from 300 μm to 800 μm. It was also observed that the range of b/a ratios which satisfy a predetermined design criterion (e.g. δ≦0.5%) becomes wider when the upstream passage width c decreases from 800 μm to 300 μm. With a typical precision of micromachining of about 5 μm, flow non-uniformity would rise 1.5 times (from δ=0.16% to 0.27%) with c=800 μm, and only 1.3 times with c=400 μm when the passage is not properly assembled. Thus, the choice of width c of the upstream passage is a trade-off between the required uniformity of flow and production cost, which are considerably higher for small channels.

The influence of different design parameters of a thick-walled inlet section 10 on the flow non-uniformity δ has been analyzed. The flow non-uniformity δ does not depend on the flow distribution entering the upstream passage 12 and is defined by geometry of the inlet section 10 only. Therefore, the expansion angle α of the diffuser 11 plays no role in equalizing the flow. It is recommended to use diffusers 11 with α close to 180° simply to minimize the volume of the inlet section part 21.

The proper screen configuration can effectively enhance the fluid flow uniformity. When the inlet section is proper in length (relative length of both upstream and downstream passage>7.5), the width c of vertical channels 15 does not exceed 1000 μm (c<1000 μm) and the channels are equally distributed, the ratio of the maximum flow velocity to the minimum flow velocity may drop from 2 to 1.005 for a wide range of Reynolds numbers.

As the present inlet section provides a very uniform fluid flow at the outlet side, the present inlet section is also very suitable for controlling the temperature of the fluid flow in a very uniform manner. For this, the inlet section 10 is provided with heating devices 22, which may be positioned in upstream passage 12, and/or downstream passage 13, as shown in FIG. 3. Also, temperature sensors 23 may be provided in one or more of the parts 11 . . . 13 of the inlet section 10.

At low Reynolds number, the flow in the inlet section passages 12, 13 is laminar. In this regime there is a linear flow resistance relation between the pressure drop Δp along the channel 15, 16 and the flow Q through the channel 15, 16 with a length L is Q=GΔp, where G is a hydraulic conductance. At the interface between the upstream and downstream passages 12, 13, flow is split up and redistributed in the downstream channels 16. To compare the hydraulic resistance of different parts of the thick-walled screen 10, the geometry was decomposed into regular pieces. In this approach, the top and bottom parts of an upstream passage merged together form a rectangle with height z_{V1}, while the middle part can be considered as parallel plates with height z_{V2}. For the geometry applied: z_{V1}=2.(0.5·a+b+d), z_{V2}=2(a+d). Obviously, there is a difference in hydraulic conductance for the fluid flow between the side and the middle parts of an upstream passage 12 represented in the present model by a rectangle and parallel plates, respectively. Therefore, to determine the flow rate via the rectangle and parallel plate geometry, it is necessary to calculate their hydraulic conductance, the pressure drop being the same.

In the present analysis, instead of the actual velocity field entering each downstream channel 16, an average value has been taken for the whole passage (Q_{H}). This average value depends on the mean velocity over a corresponding part of an upstream compartment (Q_{V}) and the b/a ratio. In order to provide a uniform flow distribution in the downstream channel 16, volumetric flow rate Q_{H1} has to be equal to Q_{H2} and so on. Due to the symmetry of the screen only a half of the geometry of the downstream passage 13 has to be considered. It has been found that the ratio between the flow rate in the first and the second downstream passages is equal to the ratio of the volumetric flow rates via corresponding cross-section of the upstream passages times the height of the corresponding cross-sections:

$$\frac{{Q}_{H 1}}{{Q}_{H 2}} = \frac{{Q}_{V 1}}{{Q}_{V 2}} \frac{{z}_{V 1}}{{z}_{V 2}}$$

The correction factor z_{V1}/z_{V2} counts for the pressure losses when the fluid moves from the upstream passage 12 to the downstream passage 13 of the screen. The reason for the correction factor can be understood if looking at the flow lines near the interface between the upstream and downstream passages, as shown in FIGS. 5a and 5b. For the case when b=0.5*a, flow Q_{V1} is less than Q_{V2} and, according to the CFD results, flow separation in upstream channels 15 happens above equidistant plane A12 between the first and second downstream channels 16. As a result, more fluid goes to the second downstream channel 16 and less in the first one. This is due to the presence of an external wall which creates an additional resistance to the flow. To distribute flow equally, an additional room has to be created by increasing the area of the rectangle comparing to the area of the parallel plates.

If the flow between the first and second downstream channels 16 is equally distributed, flow separation between all subsequent downstream channels 16 would always happen in corresponding equidistant planes (A23, A34, etc.) between the adjacent downstream channels 16 due to the symmetry of the screen geometry. Therefore, the problem of flow equalization in a thick-wall screen at low Re numbers reduces to that of flow equalization in the first and second downstream channels 16. In other words, the flow via the rectangle and parallel plate parts of the upstream passage 12 times their height ratio has to be the same:

$$\frac{0.5 \cdot a + b + d}{a + d} \frac{{Q}_{V 1}}{{Q}_{V 2}} = 1$$

For isothermal, steady, incompressible flow of a Newtonian fluid through a duct of arbitrary cross section, the product of the Fanning friction factor, ƒ_{F}, and the Reynolds number is a constant: the Poiseuille number, Po:

Po=ƒ_{F}Re

The Po number depends on both the channel aspect ratio, and the dimensionless length. A response function may be defined as follows

$$f ( a , b , c , d , {x}^{+} ) = \frac{{Q}_{H 1}}{{Q}_{H 2}} = \frac{{( a + 2 b + 2 d )}^{4}}{{( a + 2 b + c + 2 d )}^{2} {( 2 a + 2 d )}^{2}} \frac{{Po}_{V 2}}{{Po}_{V 1}} ,$$

which defines the ratio of flow entering the first and second downstream channel 16.

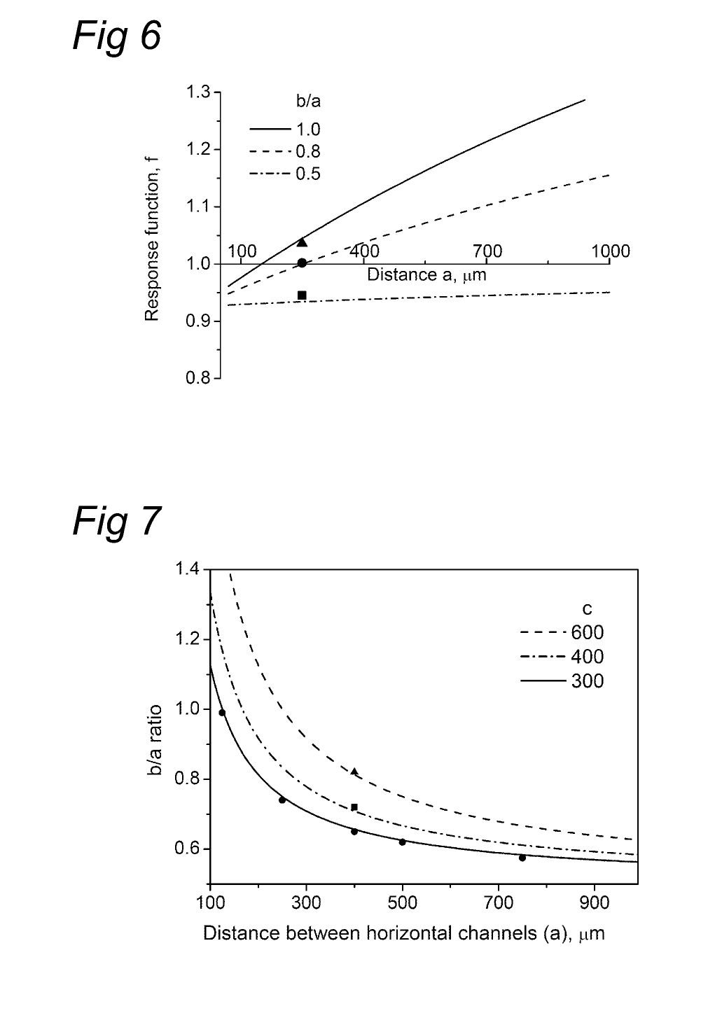

In order to assess the validity of the screen model, the design results obtained by using this model are compared with CFD simulation results. As a starting point, the model predictions obtained at a=250 μm, c=300 μm, d=2000 μm, and x⁺=0.9 are compared with the CFD results where the geometry of the diffuser module was similar to that of a thick-walled screen. FIG. 6 shows the ƒ-values as a function of distance a for three different b/a ratios of 0.0, 0.8 and 1.0. Symbols represent the ƒ-values at a=250 μm calculated based on the CFD results. It can be seen that a rather good agreement between the CFD results and model predictions is observed for all three cases. At the same time, it can be seen from the figure that the optimum b/a ratio becomes lower at larger distances a between downstream channels 16 and vice versa. Therefore, a higher b/a ratio of 1.0 has to be applied for flow equalization at a=150 μm. These results are in line with observations made earlier that increasing the separation a between the downstream passages 16 shifts the optimum b/a ratio to the lower values. In the latter example, CFD simulations give the optimum b/a ratios of 0.75 and 0.62 for a=250 and 500 μm, respectively, while other design parameters are fixed at the following values: c=300 μm, d=400 μm, x⁺=0.4. Predictions made by the present model give optimum values of 0.759 and 0.628, respectively. Thus, there is hardly any difference between the both design results. It is clarified that the proposed model can derive the good design of the screen in a wide range of design parameters.

The model can be applied to predict the influence of different design parameters a, c, d, and x⁺ on the offset b which governs the flow behaviour at the interface between the upstream passage 12 and downstream passage 13 of the screen 10 and is responsible for flow distribution. From the discussion above, it becomes clear that as distance a increases, b/a ratio has to be reduced to obtain flow equalization in the whole range of values of distance a. Therefore, the problem can be formulated as finding an optimum fit, which minimizes the flow uniformity index ε defined as:

$$ɛ = [ \frac{1}{1000 µm - 100 µm } {\int }_{100 µm}^{1000 µm } \frac{{( a + 2 b + 2 d )}^{4}}{{( a + 2 b + c + 2 d )}^{2} {( 2 a + 2 d )}^{2}} \frac{{Po}_{V 2}}{{Po}_{V 1}} \cdot d a ] - 1$$

The index ε is the average value of the response function ƒ on the interval of values a between 100 and 1000 μm, which are of interest for micro-reactor applications. Several functions with two fitting parameters can be used to describe the ensemble of data points generated by the screen model. In their discrimination, the following criteria were applied:

ε≦1·10⁻⁵; and

|ƒ(a,b,c,d,x⁺)−1|≦0.005 for 100≦a≦1000(μm)

The first criterion is set to minimize the flow-non uniformity in the whole range of values of parameter a. The second criterion is responsible that at any given value of parameter a, the flow non-uniformity will not exceed 0.5%. To satisfy the constraints given by the above equations, a fitting function for b/a ratio can be found in the form:

$$\frac{b}{a} = P 1 + \frac{P 2}{a}$$

The flow equi-partition is achieved in the whole range of a-values for different values of parameters c and d if the b/a ratio is a function of distance a and fitting parameters P1 and P2 are properly chosen, see Table 1 below.

TABLE 1
Fitting parameters for the offset b: b(a) = P1 · a + P2, x⁺ = 0.9

| c [μm] | d [μm] | P1 [-] | P2 [μm] |
|---|---|---|---|
| 300 | 400 | 0.500 | 57.00 |
| 300 | 2000 | 0.500 | 56.65 |
| 600 | 400 | 0.500 | 115.8 |
| 600 | 2000 | 0.500 | 113.4 |

Looking at Table 1 it can be observed that parameter P1 is 0.5, while parameter P2 depends on parameters c and, in less extend, on parameter d. Therefore, the fitting function can be rewritten as follows:

b(a, c, d)=0.5·a+P2(c, d)

This equation shows that parameter P2 can be neglected if a>>2·P2. If the value of parameter a twenty times exceeds P2 value, the contribution of the latter parameter is below 10%. Therefore, P2 can be neglected if a>2.3 mm because maximum values of parameter P2 are found to be ca. 115 μm (see Table 1). This is a typical situation for monolith reactors. However, micro-reactors have typical separation a between the adjacent sets of channels 16 of less than 1 mm, at which contribution of P2 is rather substantial. Therefore, it is necessary to establish the dependence of parameter P2 on design variables c, d and x⁺.

At first, parameter x⁺ was fixed at 5.0 corresponding to the fully developed flow in the upstream passages, and the values of parameter P2 were calculated for a wide range of values of design parameters c and d: 200-800 and 200-2000 μm, respectively. In these calculations, the functional dependence of b(a) according to the above equation was applied to reach flow equi-partition in the whole range of values of parameter a of 100-1000 μm. When d/c ratio becomes larger than 5, the linear growth of parameter P2 with increasing distance c is observed. Based on these observations, the following fitting function for parameter P2 was chosen:

P2(c, d)=P2A+P2B·c+P3(c, d)

The slope of the curves (P2B) remains constant (0.16780±0.00005) when d/c ratio exceeds 5 and slightly increases with decreasing d/c ratio. A new parameter (P3) is introduced to describe the deviation of P2 from the linear behaviour at low d/c ratios. When the values generated by the screen model were fitted using this equation over the entire range of parameters c and d, it was found that the y-intercept (P2A) was always 0.0±0.1 μm. Therefore, this equation can be rewritten as

P2(c, d)=0.1678·c+P3

Dividing both parts by 0.1678·c, we have

$$\frac{P 2}{0.1678 \cdot c} - 1 = \frac{P 3}{0.1678 \cdot c}$$

The value

$$\frac{P 2}{0.1678 \cdot c} - 1$$

of as a function of the height d of downstream channels 16 may be determined at several different values of the width c of the upstream channels 15. It can be shown that at small value of parameter c of 300 μm, P3 contribution approaches zero already at d=1500 μm. At a larger value of parameter c of 500 μm, this happens at d=2500 μm. The higher the value of parameter c, the higher the value of parameter d at which the contribution of P3 to P2 can be neglected. However, the d/c ratio, beyond which the contribution of parameter P3 becomes negligible, remains constant and is approximately 5.

The values of P3 as a function of d/c ratio become less than 0.1 μm when d/c>5 for the whole range of values of parameter c. When the y-axis is plotted in the logarithmic scale versus d/c values, the symbols from the straight lines for all values of parameter c and the slope of all curves is the same. This suggests that the fit for P3 has to be an exponential function over the entire range of d/c values:

$$P 3 ( c , d ) = P 3 D ( c ) \cdot {e}^{- P 3 E \cdot \frac{d}{c}}$$

The fitting results give very close P3E values of 1.020±0.001 for different values of parameter c. Therefore, P3E parameter was fixed and the dependence of P3D on c was evaluated. The values were fitted by the second order polynomial function within 5% accuracy:

P3D(c)=P3A+P3B·c+P3C·c²

The fitting parameters are listed in Table 2 below.

TABLE 2
Fitting Parameters

| Parameter | Value | 95% | Fitting range |
|---|---|---|---|
| b | P1B · a + P2 | — | 50 ≦ a ≦ 1000 (μm) |
| P1B | 0.500 | ±1.0 · 10⁻³ | |
| P2 | P2B · c + P3 + P4 | — | 200 ≦ c ≦ 800 (μm) |
| P2B | 0.1678 | ±5.0 · 10⁻⁵ | |
| P3 | $P 3 D \cdot exp ( - P 3 E \cdot \frac{d}{c} )$ | — | $0.25 \leq \frac{d}{c} \leq 10$ |
| P3A | −1.06 | ±0.05 | |
| P3B | 8.47 · 10⁻³ | ±0.08 · 10⁻³ | |
| P3C | 8.00 · 10⁻⁶ | ±0.07 · 10⁻⁶ | |
| P3D | P3A + P3B · | — | 200 ≦ c ≦ 800 (μm) |
| | c + P3C · c² | | |
| P3E | 1.020 | ±0.001 | |
| P4 | P4X · exp(−0.840 · | — | x⁺ ≧ 0.4 |
| | x⁺+0.1986 · (x⁺)⁻¹) | | |
| P4X | 3.50 · 10⁻² | ±0.20 · 10⁻² | 200 ≦ c ≦ 800 (μm) |
| | | | 200 ≦ d ≦ 2000 (μm) |

So far, all calculations were carried out at x⁺ values corresponding to the fully developed flow in the upstream passages (x⁺>5). However, often the shorter length of the upstream passage 12 of the diffuser 10 can provide an even flow distribution in the downstream channels 16. Thus, it is of particular interest to study the dependence of P1, P2 and P3 when parameter x⁺ decreases. In this study, the low limit of x⁺ values was set at 0.4, because beyond this value, the contribution from normal velocities to the overall velocity vector becomes substantial for the set of design parameters applied in this study. As a result, such screen may not be considered as a thick-walled screen any longer.

The dimensionless length x⁺ is another important parameter affecting the flow distribution in a thick-wall screen. Parameter P2 increases with decreasing x⁺. Therefore, as opposite to P3, contribution of P4 is directly proportional to parameter c:

P2=(0.1678+P4(x⁺))·c+P3(c, d)

It has been found that the plots of P4 as a function of x⁺ are located very close to each other and can be generally described by the same fitting function. It should be noted that at least three fitting parameters are required to get a good correlation between the fit and model prediction within a maximum error of 3%.

$$P 4 ( {x}^{+} ) = P 4 X \cdot {e}^{P 4 E 1 \cdot {x}^{+} + \frac{P 4 E 2}{{x}^{+}}}$$

In this fit, the parameters in the exponent do not depend on design parameters c and d. The regression analysis performed on four curves corresponding to the extreme values of design parameters c and d, gives the values of P4X=0.035±0.001, P4E1=−0.840±0.001, and P4E2=0.1986±0.004. Using this value, the maximum deviations of the data obtained by the screen model from the correlation given by the equation above are 2.7% for the 1.5<x⁺<3 range and always below 1.5% for 0.4<x⁺<1.5 and x⁺>3.

From the above, the design equation for a thick walled screen 10 can be obtained:

$$b ( a , c , d , {x}^{+} ) = 0.5 \cdot a + ( 0.1678 + 0.035 \cdot {e}^{- 0.840 \cdot {x}^{+} + \frac{0.1986}{{x}^{+}}} ) \cdot c ++ ( - 1.06 + 8.47 \cdot {10}^{- 3} \cdot c + 8.00 \cdot {10}^{- 6} \cdot {c}^{2} ) \cdot {e}^{- 1.02 \cdot \frac{d}{c}}$$

The fitting function describes well the whole range of design parameters with only a somewhat higher deviation of 4.2% at c=200 μm, d=200 μm and x⁺=0.4. Thus, it can be used for predictions of parameter P2 to design the upstream section of a thick-walled screen.

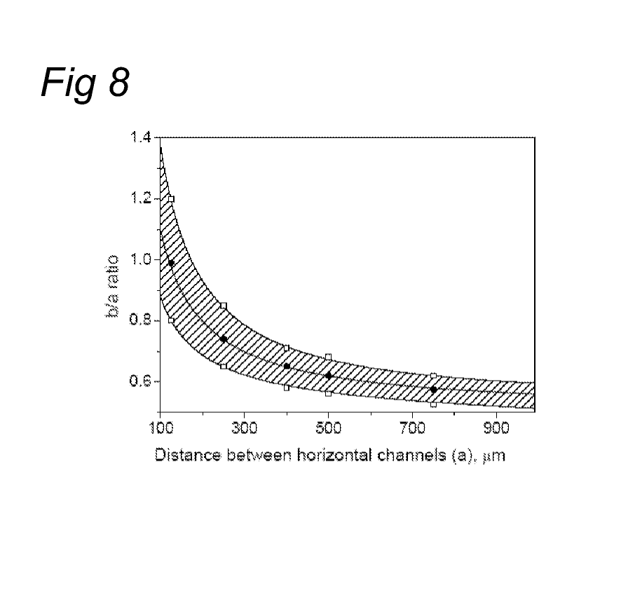

The comparative CFD data were collected using a software program for a selected number of geometries of a thick walled screen 10. In this work, the CFD code software program was used to simulate the fluid flow distribution and pressure drops along the screens. CFD results indicates that there is an optimum b/a ratio which corresponds to the minimum of flow non-uniformity of 0.18-0.20%, as already described above. In turn, the optimum ratio shifts to the higher b/a values with decreasing the distance a between the downstream channels 16. Symbols in FIG. 7 show the optimum b/a ratios as a function of distance a between downstream channels 16. For a specific case of a=400 μm, three geometries with different values of parameter c were studied. The numerical results were found to be in good agreement with the predictions obtained by the design equation. FIG. 8 shows a safe range of b/a ratios in which the flow non-uniformity does not exceed 0.5%. The width of this range is rather constant (50 μm) for distance a between 125 and 400 μm and then increases to 60 and 70 μm for a values of 500 and 750 μm, respectively. It should be noted that the width of the safe range exceeds considerably the present precision of micromachining and assembling (ca. 5 μm).

The residence time distribution in the channels of a micro-structured device determine the performance of the device. A new systematic approach is described to design a thick-walled screen or inlet section 10 that can be positioned upstream of micro-structured devices having constraints related to flow uniformity and pressure drop. According to the present invention, the problem of flow equalization in a thick-wall screen at low Reynolds numbers reduces to that of flow equalization in the first and second downstream channels 16 of the thick-walled screen 10. In turn, this requires flow equalization in the corresponding cross sections of upstream channels 15, which can be modelled by rectangular and parallel plates geometries. The effect of the separation a between the downstream channels 16, the minimum length b between the top wall of the first downstream channel 16 and a side wall of upstream channels 15, the width c of the upstream channels 15, the height d of the downstream channels 16, and the dimensionless length x^{±} of the upstream channels 15 on the flow non-uniformity in the downstream channels 16 of a thick-walled screen 10 has been established. The exact solution corresponding to the minimum flow non-uniformity can be found by minimization of the difference between the volumetric flow in the first and the second downstream channels 16. A fitting function is proposed, which provides a good fit for the distance b as a function of design variables a, c, d, x⁺. The proposed approach has been successfully implemented for the design of a flow screen for a high-throughput micro-reactor, for a micro-reactor for fast oxidation reactions, and for laboratory test micro-reactors.

The present invention has been described above using a number of exemplary embodiments. It will be clear to the person skilled in the art, that various modifications and amendments can be made to the inlet section structure. These modifications and amendments are considered to be within the scope of protection of this application, which is defined by the appended claims.

1. Inlet section for providing a uniform flow distribution in a downstream reactor connectable to the inlet section, comprising:
an inlet diffuser for receiving a fluid flow;
an upstream passage positioned downstream from the inlet diffuser; and
a downstream passage positioned downstream of the upstream passage;
in which the upstream passage and downstream passage comprise thick wall screens, wherein the upstream passage comprises a first plurality of elongated parallel upstream channels, and the downstream passage comprises a second plurality of elongated parallel downstream channels, and the elongated upstream channels are positioned at an angle of substantially 90 degrees with respect to the elongated downstream channels.

2. Inlet section according to claim 1, wherein a b/a ratio is equal to or greater than 0.5, wherein a is the distance between two neighboring downstream channels and b is the distance in cross sectional view between a top wall of the downstream channels and a side wall of the upstream channels.

3. Inlet section according to claim 2, wherein the b/a ratio is equal to a predetermined optimum value.

4. Inlet section according to claim 2 or 3, wherein the b/a ratio is changed depending on the distance a between two neighboring downstream channels (16).

5. Inlet section according to claim 2, 3 or 4, wherein the distance b is determined as a function of design parameters a, c, d, x⁺ from the equation
$$b ( a , c , d , {x}^{+} ) = 0.5 \cdot a + ( 0.1678 + 0.035 \cdot {e}^{- 0.840 \cdot {x}^{+} + \frac{0.1986}{{x}^{+}}} ) \cdot c ++ ( - 1.06 + 8.47 \cdot {10}^{- 3} \cdot c + 8.00 \cdot {10}^{- 6} \cdot {c}^{2} ) \cdot {e}^{- 1.02 \cdot \frac{d}{c}}$$
c being the width of the upstream channel, d the height of the downstream channel, and x⁺ the dimensionless length of the upstream channel
$${x}^{+} = \frac{L}{{D}_{h} Re} ,$$
wherein L is the upstream channel length, Re the Reynolds number, and Dₕ the hydraulic radius given by
$${D}_{h} = \frac{4 A}{P} ,$$
A being a channel cross sectional area, and P being the channel perimeter.

6. Inlet section according to any one of the preceding claims, wherein the width d of the downstream channels and the space a between the downstream channels are substantially equal to the width d1 of reaction channels and the space a1 between reaction channels of the downstream reactor, respectively.

7. Inlet section according to any one of the claims 1-5, wherein the width d of the downstream channels and the space a between the downstream channels are substantially equal to the width d1 of a group of reaction channels and the space a1 between groups of reaction channels of the downstream reactor, respectively, a group of reaction channels comprising an integer number of horizontal sets of reaction channels

8. Inlet section according to any one of the preceding claims, wherein the ratio of open cross section (F_{A}) of the upstream passage and open cross section (F_{O}) of the inlet diffuser is equal to or greater than substantially 3.

9. Inlet section according to any one of the preceding claims, wherein the relative lengths of both the upstream passage and the downstream passage are equal to or greater than 7.5, wherein the relative length is equal to the ratio of the length (1) of the passage in flow direction and the hydraulic diameter (2c) of the channel.

10. Inlet section according to any one of the preceding claims, wherein the first plurality of upstream channels comprises at least a predetermined number of channels.

11. Inlet section according to any one of the preceding claims, wherein the width c of the upstream channels is equal to or less than 1000 μm.

12. Inlet section according to any one of the preceding claims wherein an opening angle of the inlet diffuser is less than substantially 180°.

13. Inlet section according to any one of the preceding claims, wherein the inlet section comprises one or more heating devices for heating the fluid flow.

14. Inlet section according to any one of the preceding claims, wherein the inlet section is provided with one or more temperature sensors.
